(19) United States
(12) Patent Application Publication
(10) Pub. No.: US 2021/0156002 A1
(43) Pub. Date: May 27, 2021

(54) CONNECTION BETWEEN FORKS AND HANGERS ON FORKS

(71) Applicant: Cascade Corporation, Fairview, OR (US)

(72) Inventors: James Jennings TAYLOR, Fairborn, OH (US); Jerry Ellison GOULD, Columbus, OH (US)

(73) Assignee: Cascade Corporation, Fairview, OR (US)

(21) Appl. No.: 17/105,962

(22) Filed: Nov. 27, 2020

Related U.S. Application Data
(60) Provisional application No. 62/941,513, filed on Nov. 27, 2019.

(51) Int. Cl. C21D 9/50; B23K 20/12

(52) U.S. Cl. CPC C21D 9/505; C21D 2211/008; B23K 20/12

(57) ABSTRACT

A method for welding at least one hanger to a fork. A friction welding process may be used to create a weld between the hanger and the fork, after which the heat-affected zone (HAZ) may be allowed to cool. Preferably the cooling occurs until martensite is formed, after which a post-tempering current is applied to the HAZ.

### CROSS REFERENCE TO RELATED APPLICATIONS

This application claims the benefit of priority under 35 U.S.C. § 119(e) to U.S. Provisional Patent Application No. 62/941,513 filed on Nov. 27, 2020, the contents of which are incorporated herein by reference in their entirety.

### BACKGROUND

The subject matter of this application relates to forks for material handling vehicles, and more particularly to improved connection structures between forks of an attachment to a material handling vehicle and hangers (hooks) by which the forks are mounted to a carriage of the load handling vehicle, as well as to methods for connecting the hooks to the forks.

Material handling vehicles typically have a mast that extends and retracts in a given direction via a carriage attached to the mast. The material handling vehicle is equipped to motivate the carriage along the mast. In order to carry loads, a generally L-shaped fork is attached to the carriage. In many instances two or more such forks are attached to the carriage and loads are carried by inserting the forks into a pallet or other convenient device on which the goods to be handled are positioned. In other instances, the goods themselves can be directly contacted by one or more forks. When carrying articles that are relatively long and tubular, such as rolled carpets for example, though, a single fork may be used to carry the load.

With the variety of configuration and spacing of loads to be carried on material handling vehicles, it is common to provide a means for the adjustment of the location of the forks relative to the carriage. If a load is to be picked up with more than one fork, then the spacing between them may need adjustment to accommodate the particular pallet or other configuration of the load to be carried. Where a single fork is to be used such as in dealing with carpet rolls then one of the forks may be removed from the vehicle and the single fork would then typically be moved to the center of the vehicle to evenly distribute the load on the vehicle wheels.

Typically, the carriage that extends relative to the mast and comprises upper and lower mounting bars. When installing forks on a carriage having upper and lower mounting bars, the forks are normally provided with a pair of hook-shaped hangers. The hangers extend toward the mast, that is, away from the load supported on the blade of the fork. The hangers will usually extend vertically with the upper hanger extending downwardly over the upper mounting bar and the lower hanger extending upwardly over the lower mounting bar.

Typically, the fabrication by which the hangers (hooks) are connected to the forks must have sufficient structural strength to withstand the various weights and stresses imparted on the joint between the fork and the hanger. Existing methods that accomplish this goal, however, require relatively long periods of time to securely create each joint. What is desired, therefore, are improved connection structures between forks of an attachment to a material handling vehicle and hangers (hooks) by which the forks are mounted to a carriage of the load handling vehicle, as well as to methods for connecting the hooks to the forks.

### BRIEF DESCRIPTION OF THE DRAWINGS

FIG. 1 shows a side view of a fork in accordance with a preferred embodiment of the invention and illustrating the attachment between the fork and the mounting bars of a carriage.

FIG. 2 shows the upper mounting bar of the carriage as illustrated in FIG. 1.

FIG. 3 shows the upper hanger of the fork of FIG. 1.

FIG. 4A shows the hanger of FIG. 3 with the pin in a first position.

FIG. 4B is a view the same as FIG. 4A but with the pin in a second position.

FIG. 5 shows an exemplary process for welding a fork to a hanger of the fork.

FIG. 6 plots hardness v. distance over a single weld made by the process of FIG. 5.

FIG. 7 plots hardness v. current and time from a trial of the method of FIG. 5.

FIG. 8 shows theoretical tempering curves of hardness v. current and time for another trial of the method of FIG. 5.

FIG. 9 plots iso-tempering current v. hardness and time from the trial of FIG. 8.

FIG. 10 plots iso-hardness as a function of current time from the trial of FIG. 8.

### DETAILED DESCRIPTION

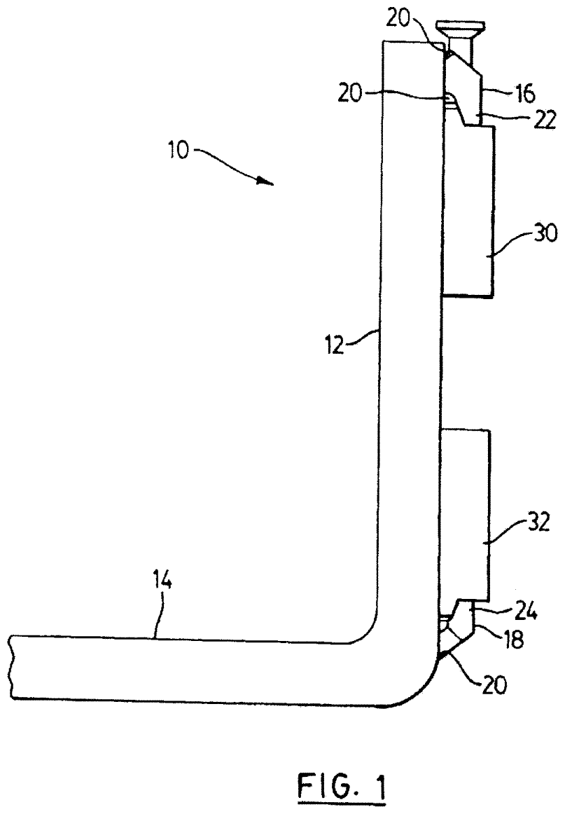

The fork 10 illustrated generally in FIG. 1 is a substantially vertical shank 12 and a substantially horizontal blade 14. Attached to the shank 12 is an upper hanger 16 and a lower hanger 18, each which may be attached to the shank 12 by welding. The welds are shown at 20 in FIG. 1. The hangers 16 and 18 comprise portions that extend from the back of the shank that is away from the blade and toward the carriage of the material handling vehicle, typically a lift truck vehicle. The hanger 16 comprises a hook 22 which extends downwardly to engage an upper mounting bar 30 of the lift truck vehicle. The lower hanger 18 also comprises a hook 24 which engages a lower mounting bar 32 of the lift truck vehicle. The two mounting bars 30 and 32 are attached to the carriage of the lift truck vehicle.

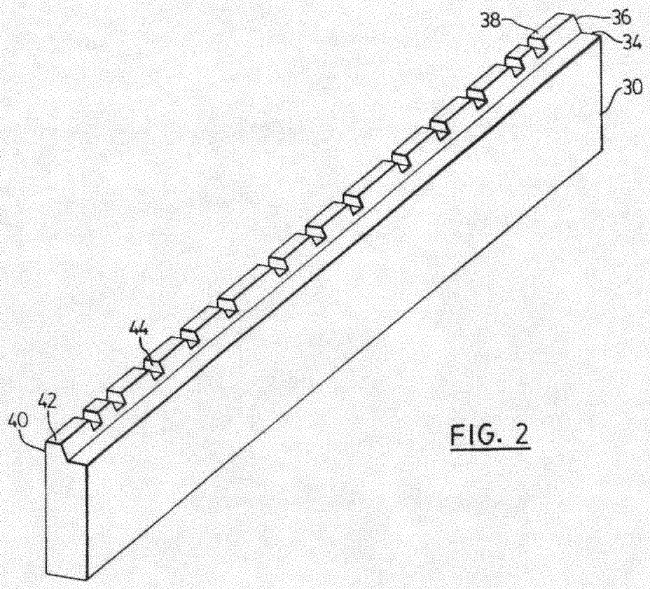

FIG. 2 illustrates the upper mounting bar 30 of the material handling vehicle carriage. The upper mounting bar comprises a substantially horizontal surface 34, a surface 36 extending at an angle to surface 34 and a surface 38 which extends substantially horizontally and parallel to the surface 34. The two surfaces 36 and 38 together with the forward-facing surface 40 of the mounting bar define a rib 42 extending along the top edge of the mounting bar 30. The rib 42 is provided with a plurality of slots 44. The slots 44 act as positioning stops to provide a plurality of fixed locations for the location of forks along the mounting bar.

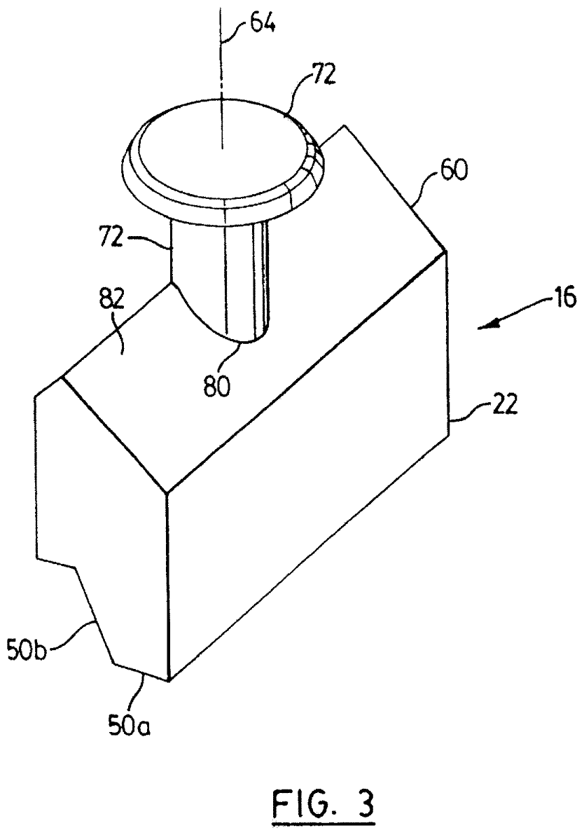

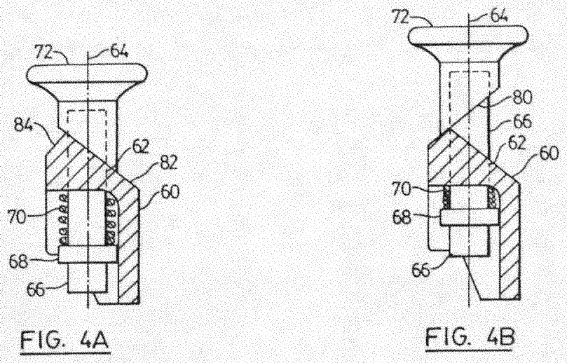

FIG. 3 illustrates the upper hangers 16 and 18 prior to connecting the hangers to the shank 12 of the fork 10 as shown in FIG. 1 The hook 22 defines a first surface 50A and 50B. The surface 50A and 50B contacts the surfaces 34 and 36 of the mounting bar 30 shown in FIG. 2. The angle between surfaces 50A and 50B is the same as the angle between surfaces 34 and 36 of the mounting bar 30. The upper hanger 16 comprises a body 60. The body 60 defines a bore 62 which extends generally vertically through the body 60. The bore defines an axis 64 for guided longitudinal movement of a pin 66 shown in FIG. 4A and 4B. The pin 66 is movable from a first position shown in FIG. 4A to a second position shown in FIG. 4B. The pin comprises a land 68. A spring 70 acts between the land 68 and the body 60 of the hanger 16 to bias the pin to the first position shown in FIG. 4A. To move the pin to the second position as shown in FIG. 4B, the spring must be compressed as shown in FIG. 4B.

As noted previously, existing techniques are capable of forming sufficiently strong joints between the hangers 16, 18 and the shank 12 of the fork 10. The existing welding process is GMAW (Gas Metal Arc Welding) process using a constant potential power source (constant voltage), a wire feeder, and a welding gun. This is done both semi-automatically, or by machine. For semi-automatic processes, the welder manually manipulates a welding gun and deposits filler material between the two parts to be welded. The base metals being welded are partially melted in the process resulting in the fusion of the base metals and filler metals. For machine applications, the welding gun is manipulated and controlled by a robotic arm.

This existing GMAW process time varies depending on the types of forks, but for the most common forks the end-to-end time takes about six minutes to clean, tack, heat, weld and clean the weld. In order to significantly reduce this time, the present inventors considered a friction welding process, which is not a fusion welding process but a solid-state welding one that generates heat by mechanical friction and deformation between workpieces moving relative to one another to plastically displace and fuse the materials. The process occurs at high surface velocities, pressures, and resulting short joining times (on the order of a few seconds) without melting. In addition, those of ordinary skill in the art will understand that the translational motions (creating friction and deformation related heating) also tend to “clean” the surface between the materials being welded. During the welding process, depending on the method being used, a small volume of the workpieces being joined will be forced out of the working bond area, carrying away residual contamination. The process then results in both rapid heating and cooling rates of the resultant bonded region.

In practice however, friction welding of fork components as a substitute for the existing GMAW process showed disappointing results. Problems included excessive joint hardness and relatively poor (compared to GMAW) mechanical performance. Specifically, the rapid cooling rates associated with the process produces a very hard and brittle martensitic microstructure both within the heat affected zone (HAZ) and deformation regions of the two attached materials. In the as welded condition, workpieces would not be acceptable for the application of mounting hangers to forks, due in part to the high hardenability of the material used in the production of these components.

Two widely accepted variants for the process of friction welding include rotary and linear friction welding. Rotary friction welding (FRW), also known as spin welding, uses machines that have two chucks for holding the materials to be welded, one of which is fixed and the other rotating. In a direct-drive type of rotary friction welding (also called continuous drive friction welding) the drive motor and chuck are connected. The drive motor is continually driving the chuck during the heating stages. Usually, a clutch is used to disconnect the drive motor from the chuck, and a brake is then used to stop the chuck. In the inertia welding (FRW-I) process, a flywheel is used to store rotational energy. For welding, the flywheel is brought to speed, the drive motor disengaged, and the work pieces are forced together. The kinetic energy stored in the rotating flywheel is dissipated as heat at the weld interface as the flywheel speed decreases. The applied force is then maintained after the spinning stops to complete forging of the workpieces.

Rotary friction welding is generally only applicable to circular sections. The hanger-to-fork connection implies a more complex geometry (e.g. rectangular) and is therefore not conducive to rotary friction welding.

Linear friction welding (LFW) is related to FRW but employs translational oscillating motion rather than rotational motion to create friction and deformation related heating for joining. This technology overcomes the geometry limitations for joined components discussed above. This variant of the technology employs similar cycle times and resultant cooling rates compared as FRW. In initial experiments with conventional Linear Friction Welding (LFW), it became obvious through metallurgical examination of sub-size samples that the HAZ microstructure produced would be 90%-100% martensite. This very hard and brittle microstructure that could sustain necessary loads, however, would exhibit little or no endurance to impact or fatigue.

The focus of the present inventors then shifted from conventional LFW to Low Force Linear Friction Welding (LFLFW). Materials of interest included high strength, low alloy (HSLA) and other alloy steels. Low force friction welding is a novel technology employing resistance based pre-heating of the components combined with interfacial motion similar to LFW. Initial trials with the technology were promising, but the high hardness in the HAZ was still a major concern. Trial specimens were run at with various force/current combinations in an effort to establish optimum parameters. The test samples were examined, and the HAZ hardness levels were still well above acceptable limits.

Upon completion of the initial trials, the present inventors began to focus on the hardness issue. Work initially considered two process variations to mitigate the high HAZ hardness. The first consisted of performing the LFLFW at a time in the fork production when the fork blank would retain residual heat from the heat-treating process. If the LFLFW could be performed at the correct time, the fork blank temperature could be 400° F. or higher, reducing the volume fraction of martensite in the joint and improving toughness. The second process variation explored the idea of re-initializing the resistance current used to preheat the parts immediately after welding to slow down the cooling rate.

The first process variation was eliminated quickly as the present inventors did not want to be limited by the fork temperature, and they determined that the optimum welding process would be done after the fork blank cooled to ambient temperature. The second process variation was evaluated further by examining the continuous cooling transformation diagrams for the materials being welded. The analysis of the data suggested a required cooling rate of approximately 120-150 seconds per fork weld to achieve the desired microstructure. This was impractical for the application of welding hangers to forks, as the existing procedure to do so was already of a much shorter duration, i.e. the second process variation would actually lengthen the current production welding time instead of shorten it.

At this point, despite continued failures, the present inventors considered a third approach, which would counterintuitively allow the weld to cool at a rapid cooling rate, allowing the martensite—with its associated high hardness and unacceptable brittleness—to completely form. Subsequently, a separate and controlled current was applied to the part to temper the completely formed martensite in the HAZ. This resulted in a tempered martensite microstructure improving toughness of the joint.

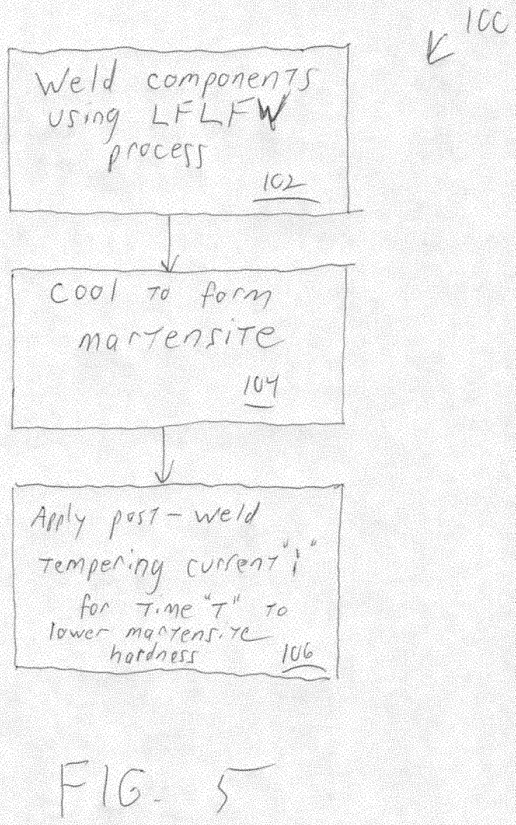

FIG. 5 generally shows a method 100 as just described where, at step 102 appropriate components are welded together using a Low Force Linear Friction Welding Process. Once the weld is complete, then at step 104 the welded components are allowed to cool so that martensite is fully formed at the weld joint. Once the martensite is fully formed, then at step 106 a post tempering current of amount “i” is applied for time “t” so as to lower the martensite hardness to an appropriate value.

Accordingly, subsequent trial runs (the second trial) were performed of the method shown in FIG. 5 applied to test blanks representing the types of materials typically used for forks and hangers on forks, with varying temper currents and temper times so as to try to find combinations of “i” and “t” values that would produce a harness at the martensite weld joint suitable for the application of hangers welded to the forks of a lift truck. Samples from this trial were then sectioned and evaluated for microstructure and hardness. These results, shown in Table 1 below, still showed some softening of the HAZ, but not consistently and with a great deal of scatter, and in many cases the HAZ hardness levels remained too high for the application of welding hangers to forks.

TABLE 1
Tempering Conditions

| | | Temper | Temper | | Avg. |
|---|---|---|---|---|---|
| | % Weld | Current | Time | | Hard. |
| Run # | Current | (kA) | (ms) | Sample# | (VHN) |
| 1 | 150 | 27 | 20 | ME162-001A | 540 |
| 2 | 150 | 27 | 216 | ME162-002 | 520 |
| 3 | 150 | 27 | 412 | ME162-003 | 460 |
| 4 | 150 | 27 | 608 | ME162-004 | 430 |
| 5 | 150 | 27 | 804 | ME162-005 | 425 |
| 6 | 150 | 27 | 1000 | ME162-006 | 400 |
| 7 | 200 | 36 | 20 | ME162-007 | 550 |
| 8 | 200 | 36 | 216 | ME162-008 | 540 |
| 9 | 200 | 36 | 412 | ME162-009 | 490 |
| 10 | 200 | 36 | 608 | ME162-010 | 345 |
| 11 | 200 | 36 | 804 | ME162-011 | 420 |
| 12 | 200 | 36 | 1000 | ME162-012 | 390 |
| 13 | 250 | 45 | 20 | ME162-013 | 545 |
| 14 | 250 | 45 | 216 | ME162-014 | 470 |
| 15 | 250 | 45 | 412 | ME162-015 | 360 |
| 16 | 250 | 45 | 608 | ME162-016 | 300 |
| 17 | 250 | 45 | 804 | ME162-017 | 395 |
| 18 | 250 | 45 | 1000 | ME162-018 | 520 |

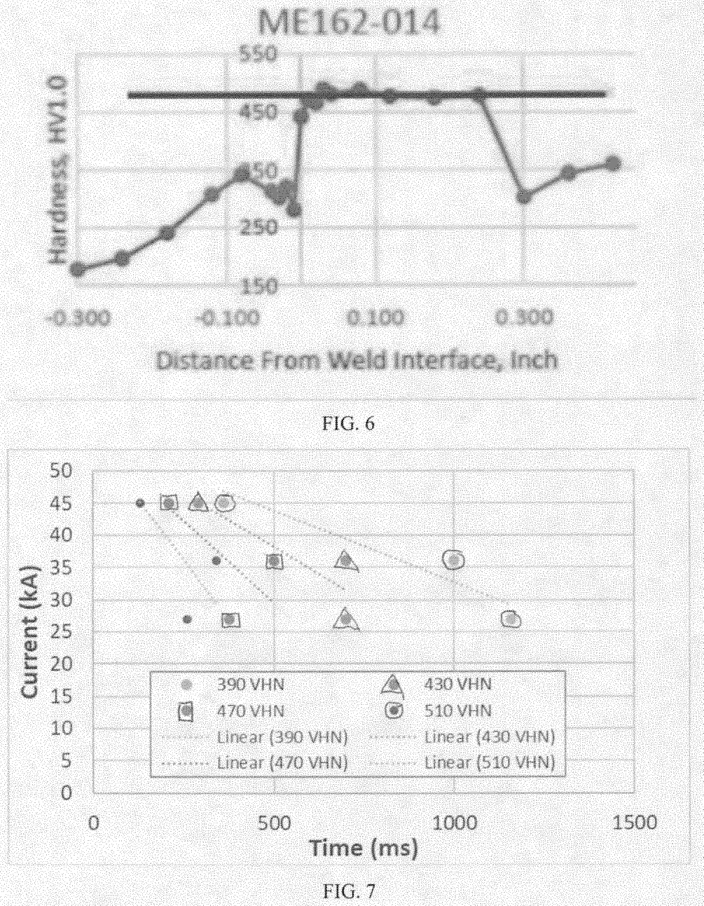

The trial producing the results shown in Table 1 was performed by using a low-force linear friction welding process to weld a sample of A572 steel to 15B37 steel, which are the materials used for forks/hangers. After the application of this welding process, the weld was allowed to cool for 20 seconds to allow martensite to fully form at the welded bond line, after which a post-weld tempering process applied varying tempering currents for varying times as shown in the table. Those of ordinary skill in the art will appreciate that, although this experiment was performed with a 20-second cooldown time, other values may be used as long as the time is such that a sufficient portion of the weld bond has transformed to martensite. After the trial welds were completed, the samples were sectioned and measured for hardness at different locations to either side of the welded bond line. A representative example of the measurement results for sample ME162-14 is shown in FIG. 6. The martensitic zone can be easily seen in this figure as the plateau in hardness at approximately 470 Vickers Hardness (VHN). The average hardness across the martensitic zone was used as an appropriate metric for performance.

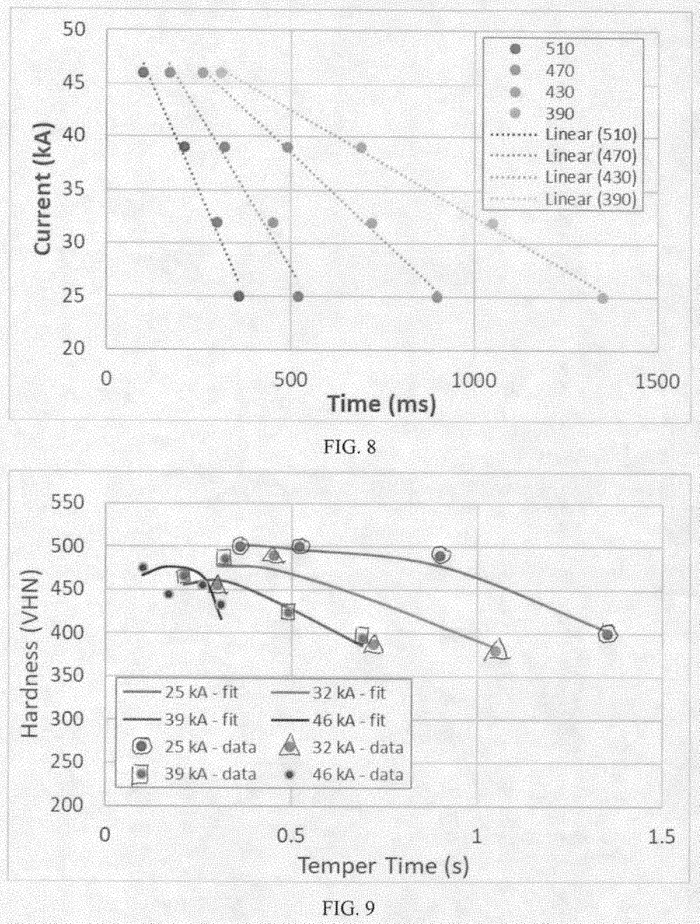

FIG. 7 is a plot of results shown in Table 1 showing iso-hardness traces, where the data in Table 1 was extrapolated to an assumed martensite hardness of 550 VHN at time zero, and best-fit linear regression lines were generated for each iso-hardness trace. As can be seen in this plot, while hardness usually decreases as a function of both current and time as shown by the linear regressions, the data is widely scattered around the best-fit lines. These plots were then used to estimate combinations of tempering currents and time intervals to are achieve specific final hardness. These results are shown in FIG. 8. The data presented here was used to develop theoretical tempering curves as described below. Sample welds were made utilizing these revised in-situ tempering curves validating the results.

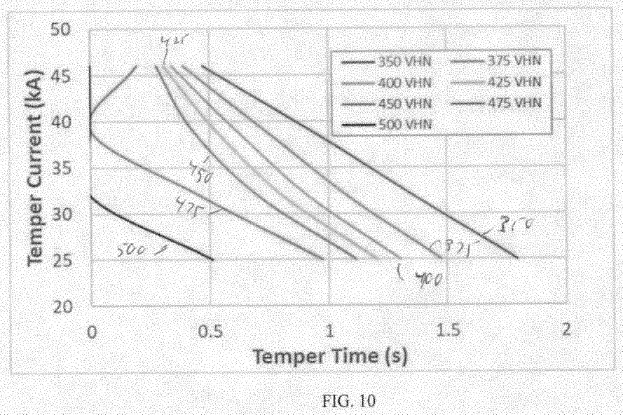

Validation included sectioning completed samples for metallurgical evaluation. The results were impressive, with controlled softening of the HAZ to acceptable levels. Table 2 below summarizes these results, while FIG. 9 plots the data as iso-tempering current curves as a function of hardness and tempering time, along with a quadratic regression for each curve. As can easily be appreciated from this figure, unlike the resulting curves from the second trial, the plotted experimental data for each is distributed fairy tightly around the relevant best-fit iso-current curve. Thus, using the test results from the third trial, effective post-weld tempering parameters of a tempering current and a tempering time may be easily selected to achieve a desired hardness of the resulting weld so as to effectively attach hangers onto forks. For example, with this improved process, it is anticipated that it would only take approximately 30 seconds per pair of forks, or 15 seconds per fork, where a pair of forks could be welded at one time. This is a substantial improvement in the manufacturing process of forks. FIG. 10 similarly plots tempering curves of iso-hardness lines as a function of tempering current and tempering time.

TABLE 2

| | Temper Cond. | | Avg. Temper |
|---|---|---|---|
| Weld# | Current (kA) | Time (s) | Zone Hardness (VHN) |
| 1 | 25 | 0.36 | 500 |
| 2 | 25 | 0.52 | 500 |
| 3 | 25 | 0.9 | 490 |
| 4 | 25 | 1.35 | 400 |
| 5 | 32 | 0.3 | 455 |
| 6 | 32 | 0.45 | 490 |
| 7 | 32 | 0.72 | 388 |
| 8 | 32 | 1.05 | 380 |
| 9 | 39 | 0.21 | 465 |
| 10 | 39 | 0.32 | 485 |
| 11 | 39 | 0.49 | 425 |
| 12 | 39 | 0.69 | 395 |
| 13 | 46 | 0.1 | 475 |
| 14 | 46 | 0.17 | 445 |
| 15 | 46 | 0.26 | 455 |
| 16 | 46 | 0.31 | 433 |

Referring again to FIG. 1, in a preferred embodiment, the weld connections 20 therefore may each preferably be formed using the low-force linear friction welding procedure previously described. As such, the weld connection 30 will preferably have a bonding surface that is substantially martensite. i.e. will have more than 90% of the micro-surface at the welded bond line of a martensite structure. The present inventors have determined that the martensite structure should preferably have an average hardness value of between 300 and 450 VHN, and more preferably between 350 and 450 VHN, although in some preferred embodiments the hardness value is between 375 and 450 VHN. Another characteristic of the weld formed by the procedure described in this specification is a large spike in hardness at the bond interface of the weld. This can be seen clearly in FIG. 6 where hardness jumps by well over 100 VHN within a spacing of less than 0.03 inches around the bond line.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A fork configured for selective engagement and disengagement with a carriage of an industrial vehicle, the fork comprising:
a shank and a hanger connected to the shank by a weld; where
the weld is formed substantially of martensite.

2. The fork of claim 1 where the martensite has an average hardness of between 300 and 450 VHN.

3. The fork of claim 1 where the martensite has a variable hardness with a spike around the bond line of the weld.

4. The fork of claim 1 where the weld is formed through a linear friction welding process.

5. The fork of claim 4 where the linear friction welding process includes a post-weld tempering process.

6. A method for welding at least one hanger to a fork for a lift truck attachment, the method comprising:
applying a friction welding process to create a weld between a hook and a fork, the weld having a heat-affected zone (HAZ);
allowing the HAZ to cool to form a weld surface comprising martensite; and
thereafter applying a post-tempering current to the HAZ.

7. The method of claim 6 where the step of allowing the weld surface to cool causes at least 90% of the welded bond line to be a martensite structure.

8. The method of claim 6 where the post-tempering current is between 20-46 kA.

9. The method of claim 8 where the post tempering current is varied according to a curve that relates current to time.

10. The method of claim 9 where the varied post-tempering current is applied for at least 0.2 seconds.

11. The method of claim 9 where the varied post-tempering current is applied for at least 5 seconds.

12. The method of claim 9 where the varied post-tempering current is applied for at least 1 second.

13. The method of claim 6 where the friction welding process is a linear friction welding process.

14. The method of claim 6 where the martensite of the weld surface has an average hardness of between 300 and 450 VHN.

15. The method of claim 6 where the martensite has a variable hardness with a spike around the bond line of the weld.
